(19) United States
(12) Patent Application Publication
(10) Pub. No.: US 2026/0097247 A1
(43) Pub. Date: Apr. 9, 2026

(54) Electric Vehicle Fire Suppression and Parking Management System

(71) Applicant: Victor Sotelo-Armengol, Chula Vista, CA (US)

(72) Inventor: Victor Sotelo-Armengol, Chula Vista, CA (US)

(21) Appl. No.: 19/352,252

(22) Filed: Oct. 7, 2025

Related U.S. Application Data
(60) Provisional application No. 63/704,409, filed on Oct. 7, 2024.

(51) Int. Cl. A62C 3/07; A62C 3/16; A62C 37/36

(52) U.S. Cl. CPC A62C 3/07; A62C 3/16; A62C 37/36

(57) ABSTRACT

An electric vehicle fire suppression and parking management system that integrates an electric vehicle supply equipment (EVSE) unit with an undercarriage suppression assembly containing a housing, suppressant supply, feed line, nozzle, solar panel, battery, communication module, processing unit, and sensors. The feed line delivers water or fire suppressant to the nozzle, which targets a vehicle undercarriage or adjacent stalls during fire events. Sensors, including proximity, motion, and flame detectors, monitor parking space conditions and trigger automatic or manual suppression. The housing supports solar-powered operation and wireless communication with a controller system, which connects to a cloud network via cellular communication. Multiple EVSE units operate in coordination, transmitting data to a centralized controller. The system further incorporates a user interface for operator interaction and enables real-time parking occupancy detection, unauthorized vehicle identification, and machine learning-based parking management.

### FIELD OF THE INVENTION

The present invention relates generally to electric vehicle charging stations. More specifically, the present invention is a fire suppression and parking management system directed towards electric vehicle charging stations.

### BACKGROUND OF THE INVENTION

As electric vehicles (EVs) gain increasing popularity, they are widely regarded as a viable alternative to traditional internal combustion engine vehicles due to their environmental benefits and potential for reducing dependence on fossil fuels. However, the growth of EVs has brought new challenges, particularly with regard to battery charging during long trips or short commutes. While concerns about charging time have been somewhat overemphasized, with more than 80% of EV users charging at home or work, safe charging infrastructure is paramount to ensure broader EV adoption.

To address the issue of downtime during charging, various advanced charging methods have been developed. For instance, battery swapping and ultra-fast megawatt-charging technologies are being explored to shorten charging times and improve convenience for users. Although with these advancements, the increase in charging efficiency and frequency leads to greater wear on energy storage systems, particularly EV batteries, which are subjected to stress due to higher power charges and discharge cycles. This wear may compromise the mechanical and chemical integrity of the batteries, increasing the risk of malfunctions, such as thermal runaway events, where excessive heat triggers a chain reaction of overheating and fire.

One of the primary risks during EV charging is thermal runaway in the vehicle's battery pack, damaged or malfunctioning cells overheat, ignite, and cause fires that are difficult to control. This risk becomes more pronounced when ultra-fast charging systems are involved, as the rapid inflow of energy can exacerbate pre-existing vulnerabilities within the battery, and therefore EV charging stations need robust fire suppression systems capable of detecting and responding to fire incidents promptly.

Within the prior art, fire suppression systems in various settings, including fuel stations and commercial buildings, have been based on sprinkler or extinguisher systems activated by heat or smoke detectors. For electric vehicle charging stations, however, the unique risks posed by battery fires necessitate a more specialized approach. Battery fires burn at very high temperatures and release toxic gases, complicating the fire suppression process.

While some existing EV charging stations incorporate basic fire suppression measures, such as smoke detectors and ceiling-mounted sprinklers, these are generally insufficient to effectively manage a battery thermal runaway event. Fires originating from EV batteries are often localized underneath the vehicle and spread rapidly, making it critical to have suppression systems that can target the undercarriage of the vehicle where battery fires are most likely to start. Furthermore, the prior art has demonstrated passive system, wherein said systems react only after a fire has grown, which delays response times and reduces the chances of containing the fire before it escalates.

Moreover, the issue of parking management at EV charging stations remains largely overlooked in current infrastructure designs. Unauthorized vehicles, such as those with internal combustion engines, can occupy charging stalls—often referred to as “icing” (Internal Combustion Engine-ing)—and prevent EVs from accessing these critical charging points. This inefficiency can disrupt the flow of EV charging, creating frustration for users and reducing the overall utility of the station. Existing solutions primarily involve signage or manual enforcement, which can be unreliable and labor-intensive. There is a growing need for a system that can not only manage fire risks but also ensure that parking at charging stations is optimized for EV users.

The present invention addresses both of these challenges by combining a fire suppression system tailored to EV battery fires with a parking management system that ensures only authorized vehicles occupy charging stalls. By integrating these two functionalities, the system offers a comprehensive solution for safely managing EV charging stations and optimizing their use.

The fire suppression system employs a ground-mounted, undercarriage spray nozzle configuration capable of extinguishing fires at the vehicle's undercarriage, where thermal runaway events often begin. This system can be activated via multiple systems, including the Electric Vehicle Supply Equipment (EVSE), the vehicle's battery management system (BMS), or cloud-based monitoring platforms. In the event of a fire, the system rapidly detects heat or flames using a triple IR flame detector and can be triggered remotely to suppress the fire before it spreads.

On the parking management side, the system prevents unauthorized vehicles from occupying charging stalls by using various monitoring techniques, such as camera-based license plate recognition or sensors embedded in the wheel stop. By integrating these controls, the system ensures that only EVs are able to access and park at the charging stations, maximizing efficiency and minimizing potential disruptions caused by unauthorized vehicles.

### BRIEF DESCRIPTION OF THE DRAWINGS

FIG. 1 is a perspective view of the present invention.

FIG. 2 is front view of the present invention.

FIG. 3 is a component chart of the wheel stop of the present invention.

FIG. 4 is a chart of the at least one sensor of the present invention.

FIG. 5 is a graph showing the conical spray pattern of the present invention.

FIG. 6 is a diagram of the nozzle of the present invention shown in a sectional view and a profile view thereof.

FIG. 7 is a communication diagram of the present invention.

FIG. 8 is a perspective view of a network of wheel stops.

FIG. 9 is a process diagram of the fire mitigation method of the present invention.

FIG. 10 is a process diagram of the parking management method of the present invention.

FIG. 11 is a top elevational view of the present invention wherein a vehicle occupies a parking space, demonstrating the conical spray of the fire suppression system, partially overlapping adjacent stalls.

FIG. 12 is a detailed side view of the present invention, showing the spray pattern of the fire suppression system.

FIG. 13 is a chart of the machine learning model functions.

FIG. 14 is a process diagram of the plurality of modules of the present invention.

FIG. 15 is a process diagram of the third deployment process of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header. Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of an electric vehicle fire suppression and parking management system, embodiments of the present disclosure are not limited to use only in this context.

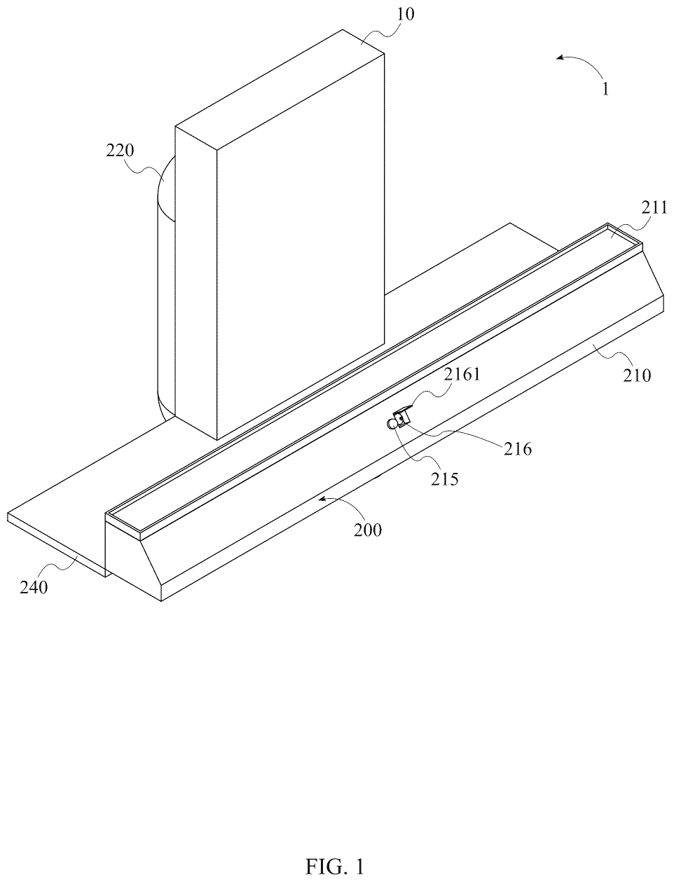

As shown in FIGS. 1-15, the present invention is an electric vehicle fire suppression and parking management system 1 comprising an electric vehicle supply equipment (EVSE) system comprising an undercarriage device 200. In the preferred embodiment of the present invention, the undercarriage device 200 is a wheel stop adjacent to an electric vehicle charging station 10.

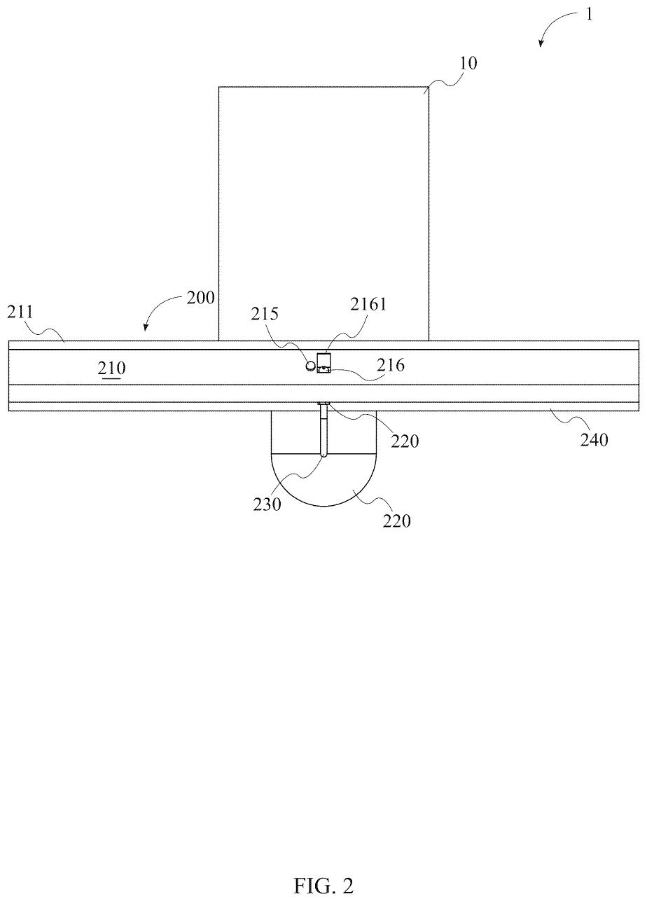

As shown in FIGS. 1-2, in the preferred embodiment of the present invention, the undercarriage device 200 comprises a housing 210, a suppressant supply 220, and a feed line 230. In the context of the present invention, the feed line communicates fire suppressant selected from water and a fire suppressant compound from the suppressant supply 220 through the feed line 230. In some embodiments of the present invention, the feed line 230 is below the surface of the ground 240. In alternate embodiments of the present invention, the feed line 230 is an above ground conduit. In the preferred embodiment, the feed line 230 is secured to the housing 210 using a lock nut 231. In the preferred embodiment of the present invention, the electric vehicle fire suppression and parking management system 1 comprises a plurality of undercarriage devices 100 wherein said plurality of undercarriage devices 100 are aligned in an array, wherein the suppressant supply 220 is fluidly coupled to each of the undercarriage devices in series by the feed line 230. Further, in some embodiments of the present invention, the undercarriage device 200 is configured as a wheel stop adjacent to a parking space 500. Moreover, in some embodiments of the present invention, the undercarriage device 200 is adjacent to a pull-through parking bay.

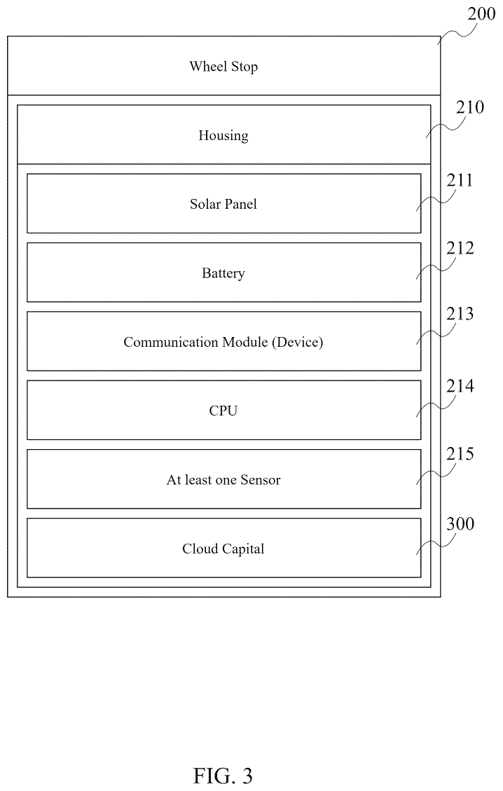

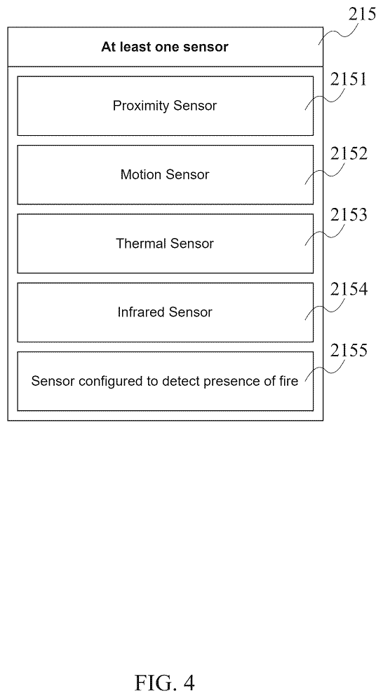

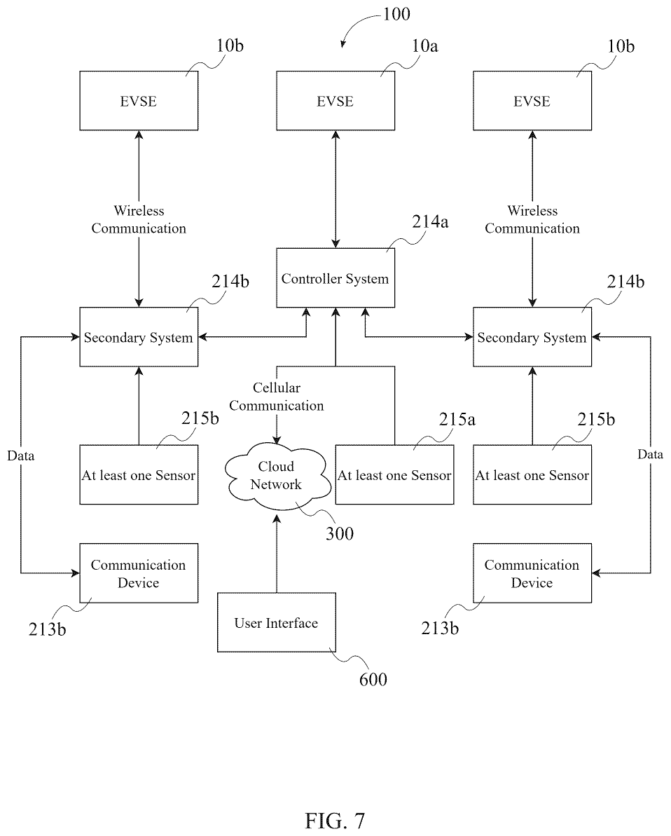

As shown in FIG. 3, in the preferred embodiment of the present invention, the housing of the undercarriage device 200 comprises a solar panel 211, a battery 212, a communication module communication device 213, a processing unit (CPU) 214, an at least one sensor 215, and a nozzle 216. In the preferred embodiment of the present invention, the battery 212, the communication module 213, the CPU 214, the at least one sensor 215 and the nozzle 216 are contained within the housing, such that the at least one sensor 215 and the nozzle 216 are positioned in a manner facing the respective parking space 500. In the preferred embodiment of the present invention, as shown in FIG. 1, the solar panel 211 is positioned on an outwardly facing surface of the housing 210, providing energy to a battery 212. In the context of the present invention, the battery 212 is a power storage unit contained within the housing 210. Additionally, as shown in FIG. 7, in some embodiments of the present invention, the undercarriage device 200 further comprises a cloud capital 300 wherein said cloud capital 300 is an internet of things (IoT) wherein the at least one sensor 215, the CPU 214 and a respective software, undercarriage device 200, and EVSE 10, connect and exchange data over the Internet and communication networks of the like. Furthermore, in the context of the present invention, the at least one sensor 215 is configured to collected input data from the external environment of the housing 210, specifically a respective parking space 500. In the preferred embodiment of the present invention, as shown in FIG. 4, the at least one sensor 215 is selected from at least one of: a proximity sensor 2151, a motion sensor 2152, a thermal sensor 2153, an infrared sensor 2154 and a sensor configured to detect the presence of fire 2155.

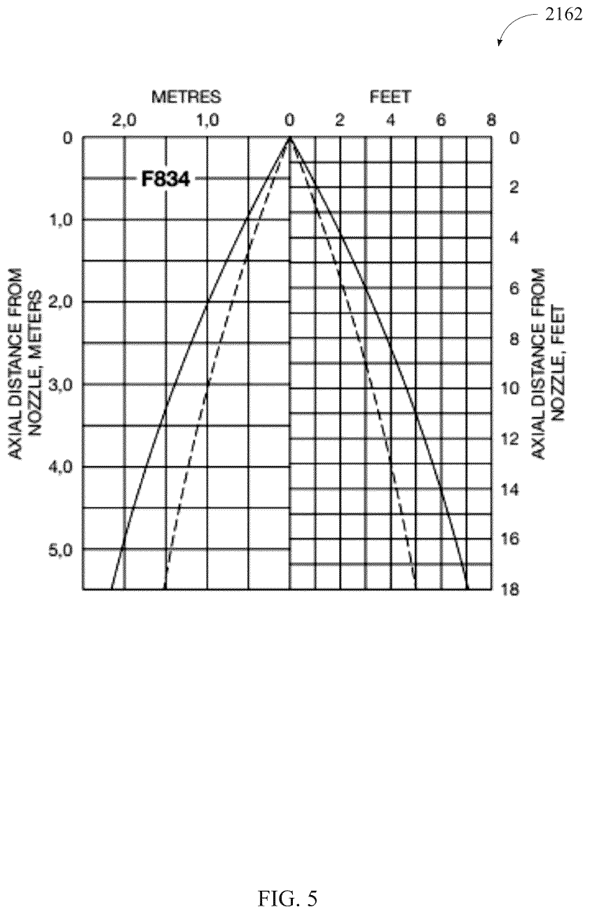

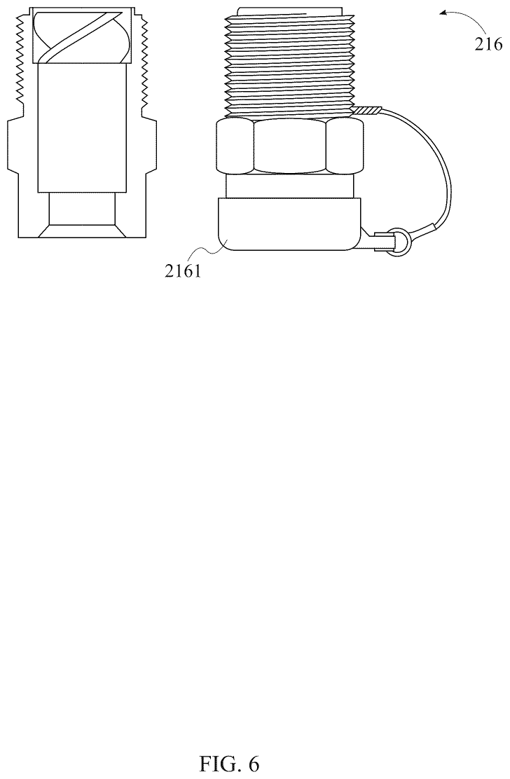

As shown in FIG. 5, in the context of the present invention, the nozzle 216 is configured to expel water or fire retardant (i.e. fire suppressant) from the feed line 230 to the respective parking space 500 and adjacent stalls to prevent the spread of the fire. In the preferred embodiment, as shown in FIG. 5, the nozzle 216 is configured to expel the fire suppressant in a conical spray pattern 2162, directed at a vehicle undercarriage wherein the vehicle battery is located. In the preferred embodiment of the present invention, as shown in FIG. 6, the nozzle 216 further comprises a dust cap 2161 wherein said dust cap 2161 is tethered to the nozzle 216 such that expulsion of the fire suppressant displaces the dust cap 2161.

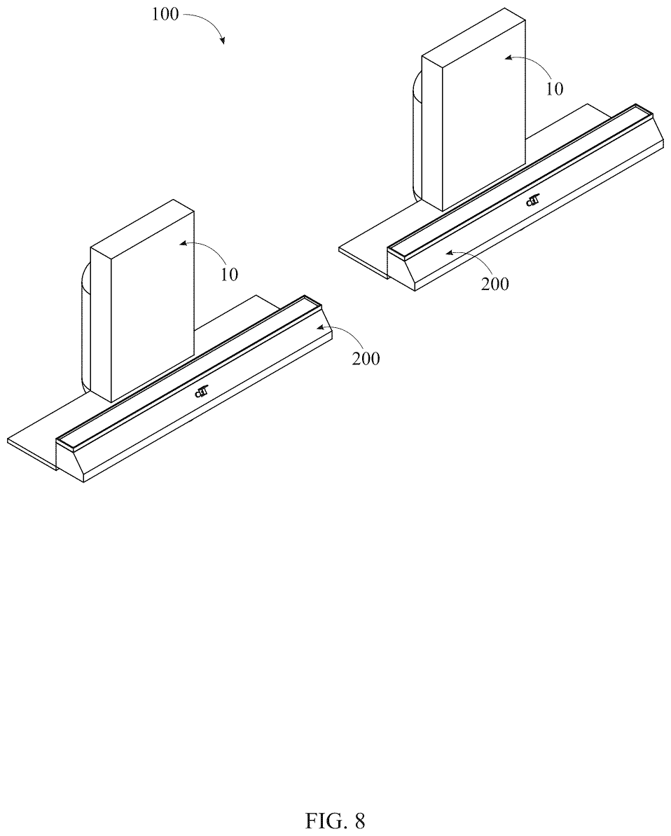

In the preferred embodiment of the present invention, as shown in FIGS. 7 and 8, the electric vehicle fire suppression and parking management system 1 comprises a plurality of EVSE systems 100 wherein said systems wirelessly communicate data to a controller system 214a. In the preferred embodiment of the present invention, controller system 214accommunicates data between at least one secondary system 214b. In the preferred embodiment of the present invention, the controller system 214a further facilitates communication with a cloud network 300 through cellular communication. In the preferred embodiment of the present invention, the communication device 213 is a SIM card, wherein said communication device 213 connects and communicates data to a local network. In the context of the present invention, the controller system comprises a SIM card, enabling the controller system 214 to communicate through cellular communication to the cloud network 300. Further, each of the secondary systems 214b comprises a wireless communication system, enabling said secondary systems 214b to communicate with the controller system 214a through a local network, thereby funneling all communications to the cloud network 300 through a single funnel (i.e. the controller system 214a). Furthermore, in the context of the present invention, the communication device 213b communicates with the secondary system 214b. In the preferred embodiment of the present invention, the electric vehicle fire suppression and parking management system 1 further comprises a user interface (UI) 600, also referred to herein as a human-machine interface (HMI), wherein the user interface 600 enables a user to interact with the system, specifically, enabling the user to deploy the fire suppression system.

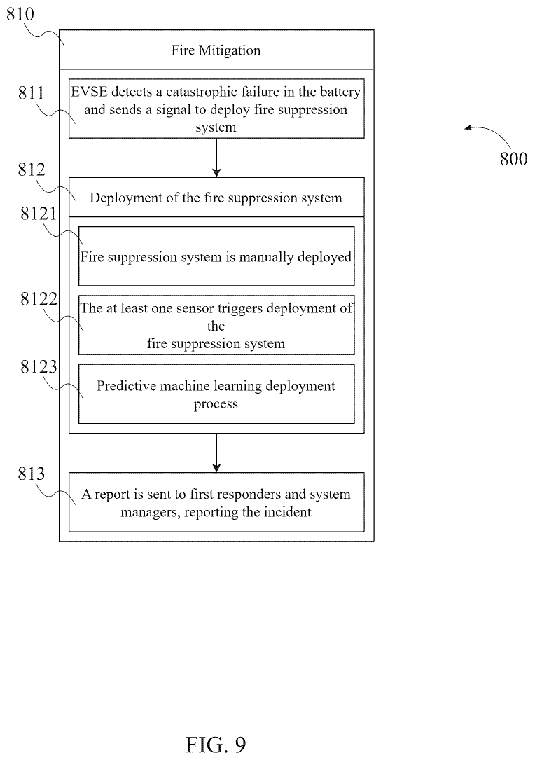

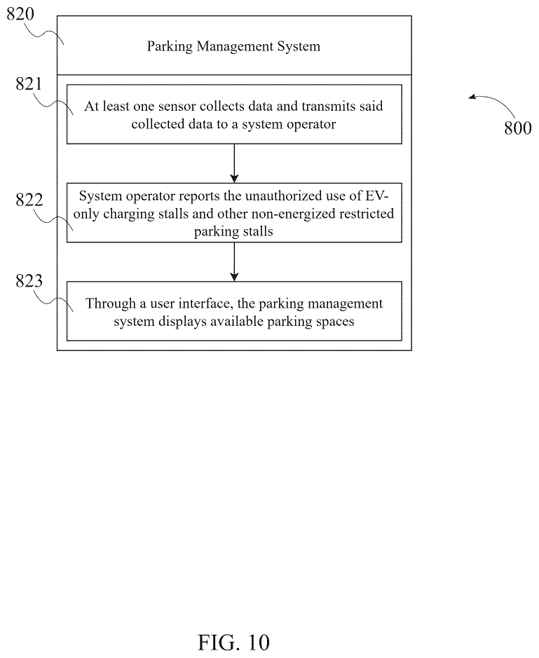

In the context of the present invention, the electric vehicle fire suppression and parking management system 1 further executes a series of computer executable methods to facilitate a fire mitigation method 810 and a parking management method 820, as shown in FIGS. 9 and 10. In the preferred embodiment of the present invention, as shown in FIG. 9, the fire mitigation method 810 comprises a first step 811 wherein the EVSE detects a catastrophic failure in the battery of an electrical vehicle occupying the respective parking space 500 and sends a signal to deploy fire suppression system.

Furthermore, in the preferred embodiment of the present invention, the fire mitigation system 810 comprises a second step 812 wherein the fire suppression is deployed. In some embodiments of the present invention, the fire suppression system is manually deployed 8121. In some embodiments of the present invention, the fire suppression system receives an input from the at least one sensor 215 wherein said input is greater than a predetermined threshold, thereby triggering the deployment of the fire suppression system 8122. Following deployment, a report is sent to first responders and system managers, reporting the incident. In some embodiments of the present invention, a predictive machine learning process 8123 may also be executed to deploy the fire suppression system 812.

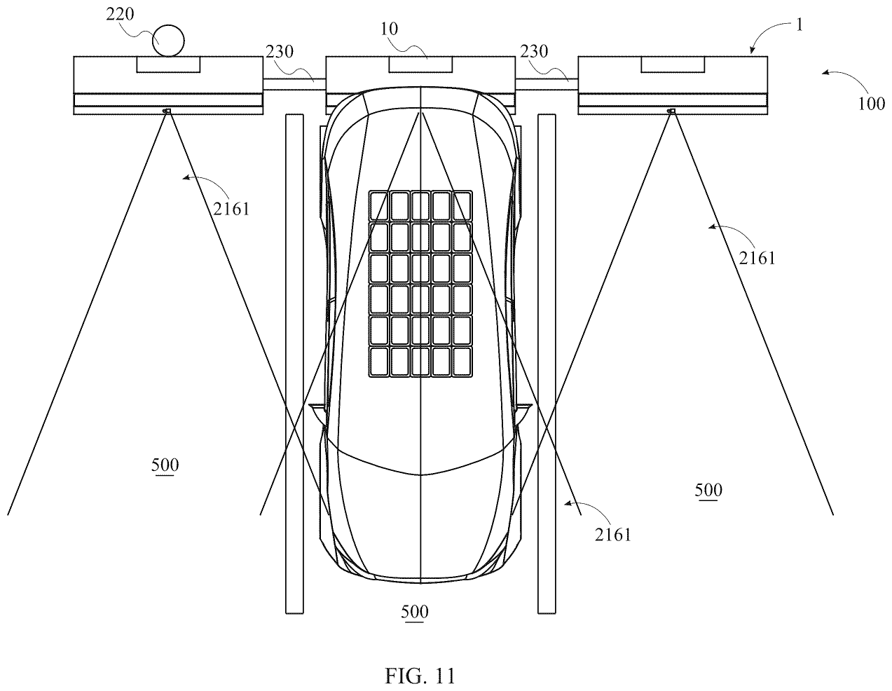

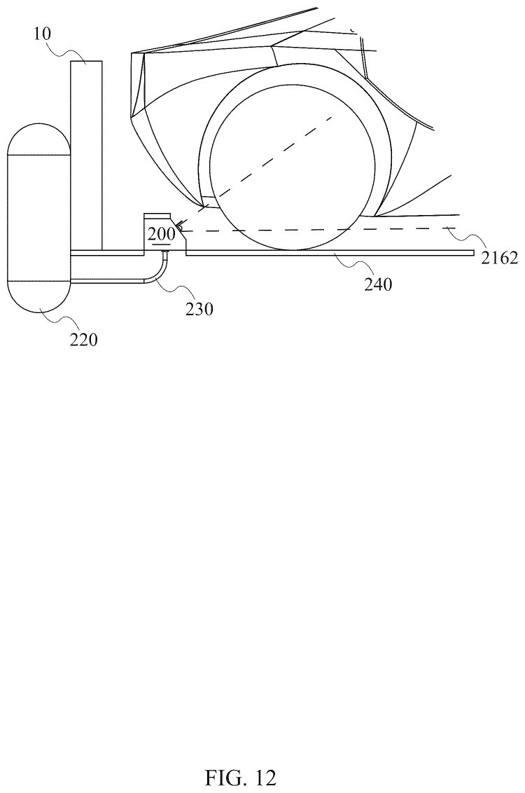

In the preferred embodiment of the present invention, upon deployment of the fire suppression system 812, the at least one sensor 215, specifically the fire sensor, determines the presence of a fire located in the undercarriage of the electric vehicle. Upon detecting the fire, the nozzle 216 expels water to the undercarriage of the vehicle in a conical pattern 2162, as shown in FIGS. 11 and 12, thereby targeting the fire directly and preventing the fire from spreading to adjacent parking spaces. In some embodiments of the present invention, the nozzle 216 expels a fire suppressant compound, such as a lithium-ion fire mitigation compound and compounds of the like. Additionally, within the preferred embodiment of the present invention, the nozzle 216 expels water, spraying a coverage spanning at least a portion of the adjacent parking spaces. Furthermore, in the preferred embodiment of the present invention, the nozzle sprays a coverage area spanning 30% of each adjacent parking space.

Furthermore, as shown in FIG. 10, in the preferred embodiment of the present invention, the parking management system method 820 comprises a first step 821 wherein the at least one sensor collects data and transmits said collected data to a system operator. In the context of the present invention, the data collected pertains to the status of a parking space wherein said data is indicative of the presence of a vehicle. Further, in the context of the present invention, the system operator is either a human operator, or an artificial intelligence operator, wherein said artificial intelligence operator controls the system. In a second step 822, a system operator reports the unauthorized use of EV-only charging stalls and other non-energized restricted parking stalls. In the context of the present invention, “unauthorized use,” also referred to as “ICE-ing” is defined as the presence of a non-electric vehicle occupies a parking space intended for electric vehicles (i.e. an electric vehicle charging station, EVSE parking space, etc.). In a third step 823, through a user interface, the parking management system displays available parking spaces. In the context of the present invention, the parking management system, being able to detect the presence of an unauthorized use of a parking space, enables the fire mitigation to effectively target electric vehicles as such vehicles possess an increased risk of combustion during charging. In some embodiments of the present invention, the parking management system method 820 utilizes a machine learning model or artificial intelligence system and a camera for detecting vehicles within parking spaces, thereby facilitating a real-time parking occupancy tracking system.

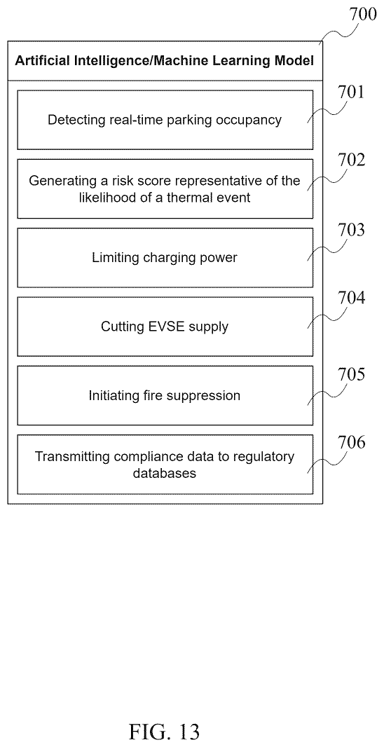

In the preferred embodiment of the present invention, as shown in FIG. 13, the machine learning model 700 is executed by the processing unit 214. In the context of the present invention, the machine learning model 700 is configured to detect real-time parking occupancy 701. Further, in the context of the present invention, the machine learning model 700 is configured to generate a risk score representing the likelihood of a thermal event 702. Further, in the context of the present invention, the machine learning model is configured to limit the charging power 703 and cut power to the EVSE 704. Further, in the context of the present invention, the machine learning model is configured to initiate a fire suppression protocol 705. Further, in the context of the present invention, the machine learning model is configured to transmit compliance data to a regulatory database 706.

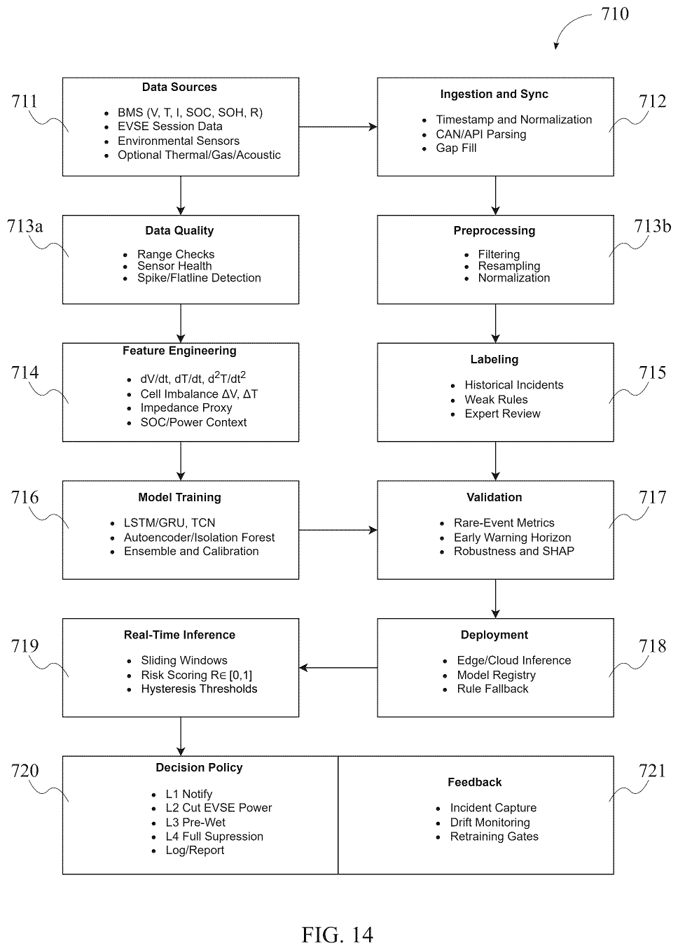

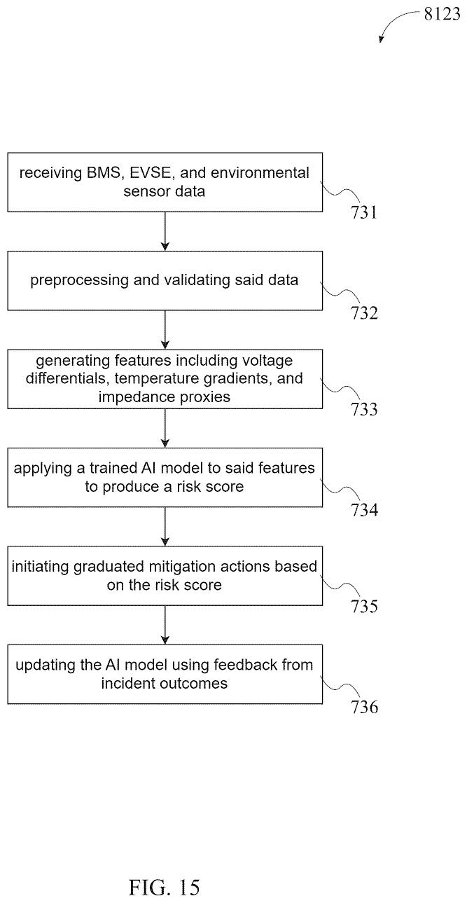

In the preferred embodiment of the present invention, as shown in FIG. 10, FIG. 14, and FIG. 15, the present invention comprises a third deployment method 8123, a predictive machine learning deployment process 8123, comprising a plurality of modules 710 wherein said modules are executed by the processing unit 214. In the preferred embodiment of the present invention, the plurality of modules comprises a data sources module 711, an ingestion and synchronization module 712, a data quality module 713a, a preprocessing module 713b, a feature engineering module 714, a labeling module 715, a model training module 716, a validation and safety module 717, a deployment module 718, a real-time inference module 719, a decision policy module 720, and a feedback and continuous learning module 721. In the context of the present invention, data is transmitted from the data sources module 711, to the data quality module 713a, then the feature engineering module 714, then the model training module 716, wherein said data is thereby communicated to the validation module 717. Simultaneously, data is communicated from the data sources module 711, to the ingestion and synchronization module 712, then the preprocessing module 713b, then the labeling module 715, and finally to the validation module 717 wherein said data is consolidated within said validation module 717. From the validation module 717, the consolidated data is communicated to the deployment module 718, then to the real-time inference module 719, and finally to the decision policy module 720. Upon data transmission between the plurality of modules 710, the feedback and continuous learning module 721 is constantly monitoring and training the machine learning model 700. In the context of the present invention, the predictive machine learning deployment process 8123 is an alternate process of step two 812 of the fire mitigation method 810. Further, within the context of the present invention, the predictive machine learning deployment process 8123 preemptively prevents a thermal event by deploying the system prior to catastrophic failure of the electric vehicle battery.

In the context of the present invention, the data sources module 711 integrates multiple sources of data: (i) BMS inputs including individual cell voltages, temperatures, currents, state-of-charge (SOC), state-of-health (SOH), and internal resistance; (ii) EVSE session data including charging power, energy delivered, and error codes; and (iii) environmental and auxiliary sensors, including temperature, humidity, thermal/optical cameras, gas sensors, and acoustic sensors.

Further, in the context of the present invention, the ingestion and synchronization module 712 synchronizes Incoming data streams to a common timestamp standard (UTC). CAN bus data is decoded, EVSE API data is parsed, and missing values are gap-filled. Redundant or duplicate records are removed.

Further, in the context of the present invention, the data quality 713a and preprocessing modules 713b perform sanity checks to validate ranges of voltage, current, and temperature. Sensor health is monitored through spike detection, flatline detection, and fault scoring. Data is preprocessed via noise filters, windowed resampling, and normalization per cell and per pack.

Further, in the context of the present invention, the feature engineering module 714 derives predictive features such as dV/dt, dT/dt, d²T/dt², impedance proxies from ΔV/ΔI, SOC-dependent behavior, inter-cell imbalance metrics (ΔV, ΔT), and thermal gradients across the pack. Event counters for BMS faults are also included.

Further, in the context of the present invention, the labeling module 715 records historical incident data and combines said incident data with rule-based weak supervision (e.g., temperature rise thresholds) to create labeled training data. Expert review refines labeling accuracy.

Further, within the context of the present invention, the model training module 716 trains the predictive model using sequence models such as LSTM, GRU, or temporal CNNs, and anomaly models such as autoencoders or isolation forests. Ensemble methods and probability calibration ensure robust and calibrated outputs.

Further, within the context of the present invention, the validation and safety module 717 validates models using rare-event metrics such as precision-recall AUC, with emphasis on early-warning horizons (lead time before thermal event onset). Robustness is tested under sensor dropouts and noise. Explainability tools such as SHAP are employed for transparency.

Further, in the context of the present invention, the deployment module 718 facilitates deployment of the trained model on edge devices at charging stations, or in cloud environments. A model/version registry ensures controlled rollouts. Rule-based fallback logic ensures safety if the AI model is unavailable.

Further, in the context of the present invention, the real-time inference module 719 continuously scores risk in sliding windows, producing a risk value R∈[0,1]. Thresholds with hysteresis and cooldown periods prevent oscillations and false alarms.

Further, within the context of the present invention, the decision policy module 720 applies graduated responses according to the risk score: Level 1: monitor and notify; Level 2: limit or cut EVSE power; Level 3: initiate pre-wetting sprinklers; Level 4: full suppression and alarm activation. All events are logged and compliance reports (e.g., NEVI data) are generated.

Further, in the context of the present invention the feedback and continuous learning module 721 feeds post-event data back into the system. Drift monitoring identifies changes in data distributions. Periodic retraining gates update the model, with expert oversight.

Although the invention has been explained in relation to its preferred embodiment, it is to be understood that many other possible modifications and variations can be made without departing from the spirit and scope of the invention.

What is claimed is:

1. An electric vehicle fire suppression and parking management system comprising an at least one undercarriage device and a cloud network wherein said at least one undercarriage device comprises:
a housing
an at least one sensor;
a nozzle
a suppressant supply; and
a feed line;
wherein:
the housing is adjacent a parking space;
the at least one sensor embedded into the housing, configured outwardly, such that said at least one sensor collects data pertaining to a thermal event and communicates said data to the cloud network;
the nozzle is embedded into the housing, configured outwardly;
the feed line configured to communicate a fire suppressant from the suppressant supply to the housing; and
the nozzle is configured to expel fire suppressant to a vehicle undercarriage.

2. The electric vehicle fire suppression and parking management system, as claimed in claim 1, wherein the at least one sensor is selected from a thermal sensor and a triple infrared sensor.

3. The electric vehicle fire suppression and parking management system, as claimed in claim 1 wherein the nozzle is configured to expel fire suppressant in a conical spray pattern.

4. The electric vehicle fire suppression and parking management system, as claimed in claim 1 wherein the nozzle further comprises a dust cap wherein said dust cap is tethered to the nozzle such that upon expulsion of the fire suppressant, the dust cap is displaced.

5. The electric vehicle fire suppression and parking management system, as claimed in claim 1 wherein the housing further comprises a battery, a communication device, and a processing unit wherein:
the battery provides power to the at least one sensor, the communication device and the processing unit;
the communication device transmitting data received by the at least one sensor to the cloud network; and
the processing unit facilitating execution of computer executable methods.

6. The electric vehicle fire suppression and parking management system, as claimed in claim 5 wherein the processing unit facilitates a fire mitigation method comprising the steps:
the at least one sensor detects a catastrophic failure and transmits a signal to initiate deployment of the fire suppressant;
the fire suppressant is expelled from the nozzle; and
a report is generated and transmitted through the communication device.

7. The electric vehicle fire suppression and parking management system, as claimed in claim 5 wherein the processing unit facilitates a parking management method comprising the steps:
the at least one sensor collects data, detecting the presence of a vehicle in the parking space;
the data collected by the at least one sensor is transmitted to a system operator; and
the system operator reports an unauthorized use of the parking space.

8. The electric vehicle fire suppression and parking management system, as claimed in claim 7, wherein the at least one undercarriage device comprises a plurality of undercarriage devices configured in an array.

9. The electric vehicle fire suppression and parking management system, as claimed in claim 8, further comprising a user interface device.

10. The electric vehicle fire suppression and parking management system, as claimed in claim 9, wherein the user interface displays data pertaining to the presence of a vehicle in a parking space.

11. An electric vehicle fire suppression and parking management system comprising:
an at least one undercarriage device;
a user interface wherein said user interface provides a visual display; and
a cloud network;
wherein:
the at least one undercarriage device comprises:
a housing
an at least one sensor;
a nozzle
a suppressant supply; and
a feed line;
wherein:
the housing is adjacent a parking space;
the at least one sensor embedded into the housing, configured outwardly, such that said at least one sensor collects data and communicates said data to the cloud network;
the housing further comprising a processing unit, a battery, and a communication device wherein said processing unit, said battery, and said communication device are contained within the housing;
the communication device transmitting data from the at least one sensor to the cloud network;
the user interface displaying information pertaining to the data collected by the at least one sensor;
the nozzle is embedded into the housing, configured outwardly;
the feed line configured to communicate a fire suppressant from the suppressant supply to the housing; and
the nozzle is configured to expel fire suppressant to a vehicle undercarriage.

12. The electric vehicle fire suppression and parking management system, as claimed in claim 11 wherein the nozzle is configured to expel fire suppressant in a conical spray pattern.

13. The electric vehicle fire suppression and parking management system, as claimed in claim 12, wherein the at least one sensor is selected from a thermal sensor and a triple infrared sensor.

14. The electric vehicle fire suppression and parking management system, as claimed in claim 13, wherein the processing unit facilitates a fire mitigation method comprising the steps:
the at least one sensor detects a catastrophic failure and transmits a signal to initiate deployment of the fire suppressant;
the fire suppressant is expelled from the nozzle; and
a report is generated and transmitted through the communication device.

15. The electric vehicle fire suppression and parking management system, as claimed in claim 14, the processing unit facilitates a parking management method comprising the steps:
the at least one sensor collects data, detecting the presence of a vehicle in the parking space;
the data collected by the at least one sensor is transmitted to a system operator;
the system operator reports an unauthorized use of the parking space; and
the user interface displays data pertaining to the presence of a vehicle in a parking space.

16. The electric vehicle fire suppression and parking management system, as claimed in claim 11, wherein the at least one undercarriage device comprises a plurality of undercarriage devices configured in an array.

17. The electric vehicle fire suppression and parking management system, as claimed in claim 11 wherein the processing unit executes a machine learning model wherein said machine learning model:
detects real-time parking occupancy;
generates a risk score representing the likelihood of a thermal event;
limits charging power;
cuts EVSE supply;
initiates fire suppression; and
transmits compliance data to regulatory databases.

18. An electric vehicle fire suppression and parking management system comprising an at least one undercarriage device and a cloud network wherein said at least one undercarriage device comprises:
a housing
an at least one sensor;
a nozzle
a suppressant supply; and
a feed line;
wherein:
the housing is adjacent a parking space;
the at least one sensor embedded into the housing, configured outwardly, such that said at least one sensor collects data pertaining to a thermal event and communicates said data to the cloud network;
the nozzle is embedded into the housing, configured outwardly;
the feed line configured to communicate a fire suppressant from the suppressant supply to the housing;
the nozzle is configured to expel fire suppressant to a vehicle undercarriage
the fire suppressant being selected from water and a lithium ion fire mitigation compound;
the nozzle is configured to expel the fire suppressant in a conical spray pattern; and
the at least one sensor is selected from a thermal sensor and a triple infrared sensor.

19. The electric vehicle fire suppression and parking management system, as claimed in claim 18, wherein the processing unit facilitates a fire mitigation method comprising the steps:
the at least one sensor detects a catastrophic failure and transmits a signal to initiate deployment of the fire suppressant;
the fire suppressant is expelled from the nozzle; and
a report is generated and transmitted through the communication device.

20. The electric vehicle fire suppression and parking management system, as claimed in claim 18, the processing unit facilitates a parking management method comprising the steps:
the at least one sensor collects data, detecting the presence of a vehicle in the parking space;
the data collected by the at least one sensor is transmitted to a system operator; and
the system operator reports an unauthorized use of the parking space.
